(19) United States
(12) Patent Application Publication
(10) Pub. No.: US 2005/0271243 A1
(43) Pub. Date: Dec. 8, 2005

(54) Speaker apparatus

(75) Inventor: Hideaki Sugiura, Tendo (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/134,467

(22) Filed: May 23, 2005

(30) Foreign Application Priority Data
May 25, 2004 (JP) 2004-155059

(51) Int. Cl. H04R 25/00

(52) U.S. Cl. 381/413; 381/404

(57) ABSTRACT

A speaker includes a speaker unit, a case, and a vibration absorber. The case includes an outer case for enclosing the speaker unit. The outer case is formed of a closed end tube, having an outer bottom plate and an outer cylindrical wall extending from a periphery of the outer bottom plate. The vibration absorber is attached to the outer bottom plate. The vibration absorber includes an elastic member attached to the outer bottom plate, and a weight attached to the elastic member.

### BACKGROUND OF THE INVENTION

1. Field of the Invention

The present invention relates to a speaker, and more specifically to the speaker having suitable acoustic characteristics by suppressing vibration of an outer case of the speaker.

2. Description of the Related Art

A conventional speaker (not shown) includes a speaker unit having an oscillation unit and a magnetic circuit for generating sound by vibrating the oscillation unit, and a case for enclosing the speaker unit. The oscillation unit includes a voice coil mounted in a later-described magnetic gap of the magnetic circuit, and a diaphragm to vibrate together with the voice coil.

The magnetic circuit includes a yoke plate made of magnetic material, formed in an annular shape, and coupled to the diaphragm through a damper; a magnet attached to the yoke plate; and a yoke made of magnetic material, and attached to the magnet. The magnetic gap is formed between the yoke plate and the yoke, and a magnetic force for vibrating the diaphragm is generated in the magnetic gap.

The case is formed of a closed end tube, having a bottom plate and a tube extending from a periphery of the bottom plate. The case encloses the speaker unit in a state that the diaphragm is exposed out of the case. The case is fixed to the yoke of the magnetic circuit and the like.

In the conventional speaker described above, a speech current is supplied to the voice coil to vibrate the voice coil for generating the sound. At this time, in reaction to the vibration of the voice coil, the yoke may be vibrated. When the yoke is vibrated, the case attached to the yoke is also vibrated. Further, owing to the vibration of the diaphragm, the air in the speaker vibrates, and owing to the vibration of the air, the case also vibrates. If the case is vibrated, an unnecessary sound caused by the vibration of the case may be added to the sound generated by the speaker unit.

Accordingly, it is an object of the present invention to provide a speaker for producing a sound having suitable acoustic characteristics.

### SUMMARY OF THE INVENTION

In order to attain the object, according to the present invention, there is provided a speaker including:
a speaker unit having an oscillation unit and a magnetic circuit for generating a sound;
a case for enclosing the speaker unit; and
a vibration absorber attached to the case,
whereby the vibration absorber includes an elastic member attached to the case and a weight attached to the elastic member.

Preferably, the case is formed of a closed end tube, having a bottom plate and a cylindrical wall extending from a periphery of the bottom plate, and the vibration absorber is attached to the bottom plate.

Preferably, the vibration absorber is installed in the case.

Preferably, specific gravity of the weight is selected to be greater than that of the case.

Preferably, the weight is made of a tungsten-resin hybrid composite, and the case is made of an aluminum alloy.

According to another aspect of the present invention, there is provided a speaker comprising:
a speaker unit having an oscillation unit and a magnetic circuit for generating a sound;
a case for enclosing the speaker unit; and
a vibration absorber attached to the case,
whereby the vibration absorber includes a vibrator having elasticity.

Preferably, the vibrator is made of a tungsten-resin hybrid composite.

The above and other objects, features, and advantages of the present invention will be better understood when taken in connection with the accompanying drawings and description.

### BRIEF DESCRIPTION OF THE DRAWINGS

FIG. 1 is a sectional schematic view showing an embodiment of a speaker according to the present invention;

FIG. 2 is a sectional schematic view a main part of the speaker shown in FIG. 1;

FIG. 3 is a sectional schematic view showing a state that an outer case of the speaker shown in FIG. 2 is vibrated;

FIG. 4 is a sectional schematic view showing another state that the outer case of the speaker shown in FIG. 2 is vibrated; and

FIG. 5 is a sectional schematic view showing a main part of another embodiment modified from the speaker shown in FIG. 2.

### DESCRIPTION OF THE PREFERRED EMBODIMENTS

### Embodiment of the Present Invention

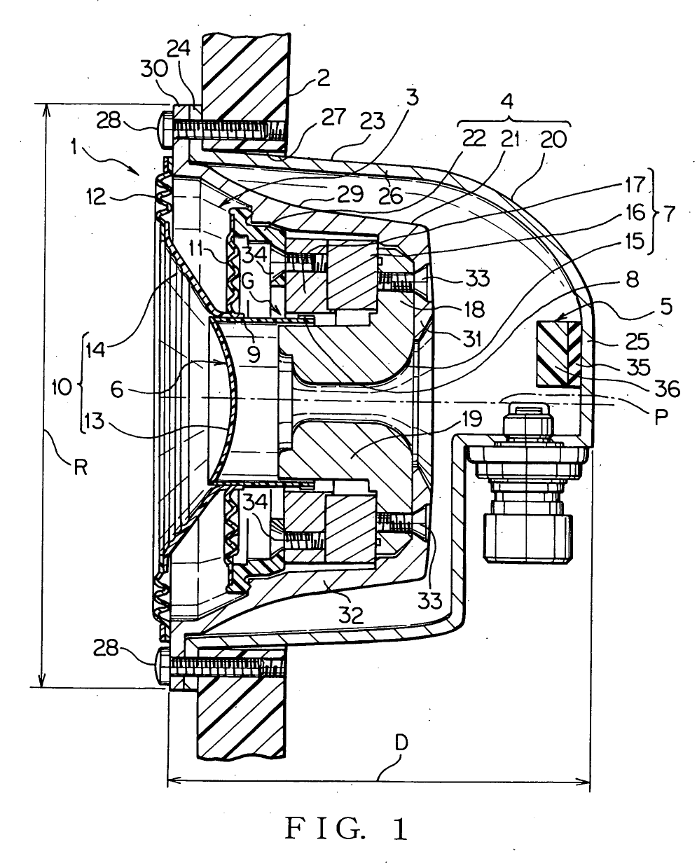

An embodiment of the present invention will be explained with reference to FIGS. 1 to 4. As shown in FIG. 1, a speaker 1 is mounted on a frame 2 of a door panel of a vehicle or a box mounted on a floor to generate a sound.

As shown in FIG. 1, the speaker 1 includes a speaker unit 3, a case 4, and a vibration absorber 5. The speaker unit 3 includes an oscillation unit 6 and a magnetic circuit 7 to vibrate the oscillation unit 6 for making the oscillation unit 6 sound.

The oscillation unit 6 includes a voice coil 8, a voice coil bobbin 9, a diaphragm 10, a damper 11, and an edge 12. The voice coil 8 is coaxial to both a later-described yoke 15 and a yoke plate 17 of the magnetic circuit 7. The voice coil 8 is arranged in a later-described magnetic gap G of the magnetic circuit 7. A speech current is supplied to the voice coil 8.

The voice coil bobbin 9 is formed in a cylindrical wall shape. The voice coil bobbin 9 is coaxial to the yoke 15, the yoke plate 17, and the voice coil 8. An end of the voice coil bobbin 9 in an axial direction of the voice coil bobbin 9 is inserted into the magnetic gap G. The voice coil 8 is attached to an outer periphery of the end of the voice coil bobbin 9. The yoke 15 supports the voice coil bobbin 9 movably along an axis P (shown by an alternate long and short dash line in FIG. 1) of the yoke 15.

The diaphragm 10 includes a thin-plated center cap 13 having an arc section and a circular shape in a plan view, and a thin-plated cone 14 having a truncated cone shape in a side view and an annular shape in a plan view. The center cap 13 is attached to the other end of the voice coil bobbin 9, and covers the voice coil bobbin 9. The cone 14 is coaxial to the center cap 13, the yoke 15, and the like. An inner periphery of the cone 14 is attached to the other end of the voice coil bobbin 9.

The damper 11 is formed in an annular shape in a plan view, and a thin-plated shape. An inner periphery of the damper 11 is attached to the voice coil bobbin 9. An outer periphery of the damper 11 is attached to a later-described support ring 22 of the case 4. The damper 11 allows the voice coil bobbin 9 to be vibrated along the axis P, and attenuates gradually the vibration of the voice coil bobbin 9.

An edge 12 is formed in an annular shape in a plan view, and a thin-plated shape. An inner periphery of the edge 12 is attached to an outer periphery of the cone 14. An outer periphery of the edge 12 is attached to a flange 24 of a later-described inner case 21 of the case 4. The edge 12 allows the voice coil bobbin 9 to be vibrated along the axis P, and attenuates gradually the vibration of the voice coil bobbin 9.

The magnetic circuit 7 includes the yoke 15 made of magnetic material (paramagnetic or ferromagnetic material), a magnet 16, and the yoke plate 17 made of magnetic material. The yoke 15 integrally include an annular bottom plate 18, and a cylindrical center pole 19 extending from an inner periphery of the bottom plate 18, and being coaxial to the bottom plate 18. An outer diameter of the bottom plate 18 is larger than that of the center pole 19. An end of the center pole 19 at a far side of the bottom plate 18 is inserted into an open end of the voice coil bobbin 9.

The magnet 16 is formed in an annular shape. The magnet 16 may be either a permanent magnet or an electromagnet magnetized by a direct-current power supply. The magnet 16 is laid and fixed on the bottom plate 18 in a state that the center pole 19 of the yoke 15 is inserted into a hole of the annular magnet 16.

The yoke plate 17 is formed in an annular shape. The yoke plate 17 is laid and fixed on the magnet 16 in a state that the center pole 19 of the yoke 15 is inserted into a hole of the annular yoke plate 17. The yoke 15, the magnet 16, and the yoke plate 17 are axial to each other. An outer surface of the center pole 19 of the yoke 15 and an inner surface of the yoke plate 17 are arranged to form the magnetic gap G.

According to the above, the magnetic circuit 7 is configured to so-called an external magnetic circuit. The magnetic circuit 7 includes the magnetic gap G between the outer surface of the center pole 19 of the yoke 15 and the inner surface of the yoke plate 17. A magnetic force for vibrating the diaphragm 10 together with the voice coil 8 is generated between the magnetic gap G.

In the speaker unit 3 having the configuration described above, the speech current is supplied to the voice coil 8. The voice coil 8 in the magnetic gap G is vibrated along the axis P corresponding to the speech current. Then, the voice coil bobbin 9 supporting the voice coil 8 is vibrated in conjunction with the center cap 13 and cone 14 of the diaphragm 10 along the axis P. Resultingly, the center cap 13 and the cone 14 of the diaphragm 10 generate a sound corresponding to the speech current. Thus, the magnetic circuit 7 vibrates the diaphragm 10 of the oscillation unit 6 for generating a sound.

The case 4 includes an outer case 20, an inner case 21, and a supporting ring 22. The outer case 20 integrally includes an outer case body 23 formed of a closed end tube, and the flange 24. The outer case 20 is made of an aluminum alloy having specific gravity of 2.7 μl cm³. The outer case 20 may be made of other metal, such as zinc.

The outer case body 23 includes an outer bottom plate 25 and an outer cylindrical wall 26 extending from a periphery of the outer bottom plate 25. The flange 24 is extended from an end of the outer cylindrical wall 26 opposed to the outer bottom plate 25 in an outward radial direction of both the outer cylindrical wall 26 and the outer bottom plate 25.

After the outer case body 23 is inserted into a hole 27 drilled on the frame 2, and the flange 24 is laid and fixed on the frame 2, the outer case 20 is fixed on the frame 2 in conjunction with the inner case 21 by bolts 28.

The inner case 21 integrally includes an inner case body 29 formed of a closed end tube, and a flange 30. The inner case 21 is made of an aluminum alloy, synthetic resin, or the like. The inner case body 29 includes an inner bottom plate 31 and an inner cylindrical wall 32 extending from a periphery of the inner bottom plate 31. The flange 30 is extended from an end of the inner cylindrical wall 32 opposed to the inner bottom plate 31 in an outward radial direction of both the inner cylindrical wall 32 and the inner bottom plate 31.

After the inner case body 29 is enclosed in the outer case 20, and the inner flange 30 is laid on the outer flange 24, the inner case 21 is fixed on the frame 2 in conjunction with the outer case 20 by bolts 28. The inner case 21 of the case 4 encloses the magnetic circuit 7 and the oscillation unit 6 of the speaker unit 3 in a state that the diaphragm 10 is exposed out of the case 4 through openings of the outer case 20 and the inner case 21. Thus, the outer case 20 encloses the speaker unit 3. After the bottom plate 18 of the yoke 15 is laid on the inner bottom plate 31, the inner case 21 is fixed on the yoke 15 of the magnetic circuit 7 by bolts 33.

The support ring 22 is formed in an annular shape. The support ring 22 is coaxial to the outer case 20, the inner case 21, and the yoke 15, and enclosed in the inner case 21. After the support ring 22 is laid on the yoke plate 17, the support ring 22 is attached to the inner case 21. The support ring 22 is fixed on the yoke plate 17 by bolts 34.

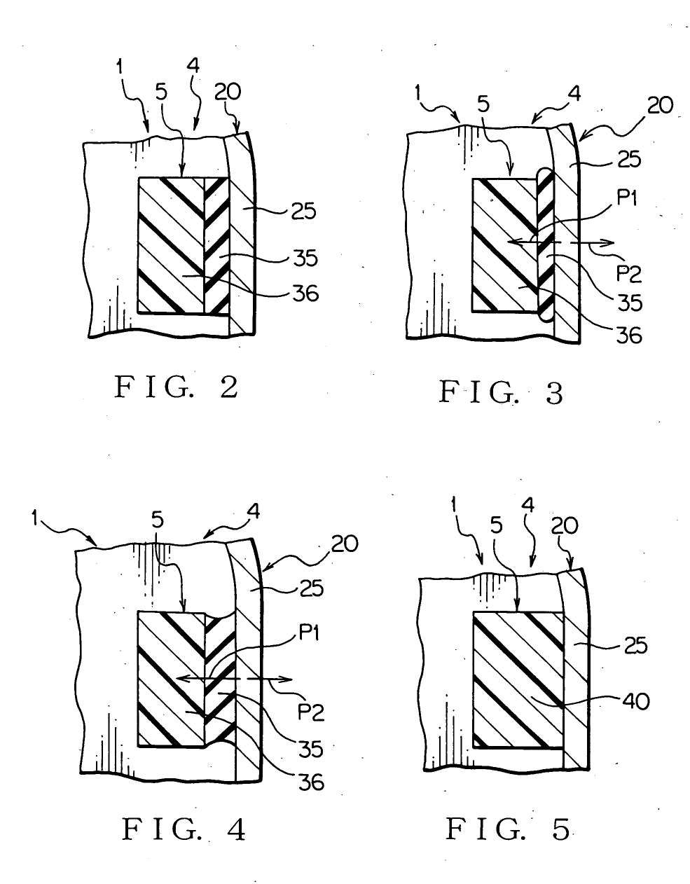

The vibration absorber 5 is enclosed in the outer case 20, and attached to the outer bottom plate 25 of the outer case 20. As shown in FIG. 2, the vibration absorber 5 includes an elastic member 35 made of such as rubber and a weight 36. The elastic member 35 is attached to the center of the outer bottom plate 25. The elastic member 35 is made of, for example, silicone rubber or nitrile rubber. The elastic member 35 is formed in a disk shape. The elastic member 35 is laid on and attached to the outer bottom plate 25.

The weight 36 is formed in a thick disk shape, and attached to the elastic member 35 while being laid on the elastic member 35. In this embodiment, the weight 36 is made of a resin of which specific gravity is selected to be greater than that of the aluminum alloy used for the outer case 20. In this embodiment, this resin is a hybrid material made of polypropylene and tungsten, so-called tungsten resin. Mixing grains of tungsten into a resin compound makes this tungsten resin. Specific gravity of this tungsten resin used for the weight 36 is 10.0 g/cm³ and is greater than that of the aluminum alloy used for the outer case 20. This tungsten resin is elastic. The weight 36 may be made of metal, such as aluminum alloy, zinc, or brass.

In the speaker 1, when the diaphragm 10 is vibrated along the axis P by supplying a voice current to the voice coil 8 of the speaker unit 3, in reaction to the vibration of the voice coil, the yoke 15 may be vibrated along the axis P in a direction opposite to the vibration of the diaphragm 10. Accordingly, this vibration of the yoke 15 is transmitted to the outer case 20 through the inner case 21, and both the magnetic circuit 7 and the case 4 may be integrally vibrated in the direction opposite to the vibration of the diaphragm 10. Further, the air in the speaker 1 is vibrated owing to the vibration of the diaphragm 10, and the outer case 20 and the like are vibrated by the vibration of the air.

Then, because of inertia, the weight 36 at rest tends to remain at rest. Therefore, the weight 36 is vibrated relative to the outer case 20 in the direction opposite to the vibration of the outer case 20. Since the elastic member 35 is mounted between the weight 36 and the outer case 20, the elastic member 35 pushes the outer case 20 toward the weight 36 and then pulls the outer case 20 against the weight 36.

For example, when the outer bottom plate 25 of the outer case 20 is moved toward the speaker unit 3 along an arrow P1 of FIG. 3, owing to inertia of the weight 36, the weight 36 pushes the outer bottom plate 25 of the outer case 20 along an arrow P2 opposite to the arrow P1 through the elastic member 35. When the outer bottom plate 25 of the outer case 20 is moved against the speaker unit 3 along an arrow P2 of FIG. 4, owing to inertia of the weight 36, the weight 36 pulls the outer bottom plate 25 of the outer case 20 along the arrow P1 opposite to the arrow P2 through the elastic member 35.

Therefore, the vibration absorber 5 immediately attenuates the vibrations of both the case 4 and the magnetic circuit 7 in reaction to the vibration of the diaphragm 10. Further, the vibration absorber 5 suppresses amplitude of the vibrations of the case 4 and the magnetic circuit 7.

According to the above embodiment, the vibration absorber 5 having the elastic member 35 and the weight 36 is attached to the outer case 20 enclosing the speaker unit 3. When the outer case 20 is vibrated, owing to the inertia of the weight 36, the weight 36 at rest tends to remain at rest. Then, the weight 36 is moved relative to the outer case 20 in a direction opposite to the vibration of the outer case 20. Since the weight 36 and the outer case 20 are coupled to each other through the elastic member 35, the weight 36 pushes and pulls the outer case 20 through the elastic member 35 in the direction opposite to the vibration of the outer case 20. Thus, when the outer case 20 is vibrated, the vibration absorber 5 suppresses the amplitude of the vibrations of the outer case 20 and immediately attenuates the vibration of the outer case 20. Therefore, an unnecessary sound caused by the vibration of the outer case 20 is prevented from being added to a sound generated by the speaker unit 3. Resultingly, the speaker 1 can produce a sound having suitable acoustic characteristics.

The vibration absorber 5 is attached to the outer bottom plate 25 of the outer case 20. Therefore, when the outer case 20 of which outer cylindrical wall 26 being attached to the frame 2 through the outer flange 24 is vibrated, the weight 36 pushes and pulls the center of the outer bottom plate 25 having a large vibration amplitude through the elastic member 35 in a direction opposite to the vibration of the outer bottom plate 25. Therefore, the amplitude of the outer case 20 is suppressed at a position having the large vibration amplitude, and is attenuated immediately. Thereby, the speaker 1 produces a sound having suitable acoustic characteristics.

Since the outer case 20 encloses the vibration absorber 5, a space occupied by the speaker 1 is prevented from increasing. Therefore, the speaker 1 is prevented from growing in size.

The weight 36 is heavier than the outer case 20. Therefore, when the outer case 20 is vibrated, the weight 36 surely pushes and pulls the outer case 20 in the direction opposite to the vibration of the outer case 20. Further, since the specific gravity of the weight 36 is selected to be greater than that of the outer case 20, a size of the weight 36 becomes small. Therefore, the speaker 1 surely produces a sound having suitable acoustic characteristics, and is surely prevented from growing in size.

Since the weight 36 is made of the tungsten resin, and the outer case 20 is made of the aluminum alloy, the specific gravity of the weight 36 can be surely greater than that of the outer case 20. Therefore, the speaker 1 more surely produces a sound having suitable acoustic characteristics, and is more surely prevented from growing in size. In addition, in the embodiment described above, the rubber is used for the elastic member 35. In comparison with a spring elastic member 35, the rubber elastic member 35, which is harder to be deformed than the spring, prevents the weight 36 from hanging down caused by gravity. Further, since the rubber is used for an elastic member 35, the elastic member 35 becomes lightweight, easy to be produced, and easy to be attached to the outer case 20, the weight 36, and the like.

Inventors of the present invention really verified an effect of the above-described vibration absorber 5 by an experiment. A result of the experiment is shown as follows.

| | | | | maximum | |
|---|---|---|---|---|---|
| | | elastic | | amplitude | |
| | outer case | member | | of the | |
| | material | material | weight material | outer case | |
| present | aluminum | nitrile | aluminum alloy | 7.0 | nm |
| invention | alloy | rubber | (specific gravity | | |
| A | (specific | | 2.7 g/cm³) | | |
| | gravity | | | | |
| | 2.7 g/cm³) | | | | |
| present | as above | as above | zinc | 6.0 | nm |
| invention | | | (specific gravity | | |
| B | | | 7.1 g/cm³) | | |
| present | as above | as above | brass | 4.5 | nm |
| invention | | | (specific gravity | | |
| C | | | 8.5 g/cm³) | | |
| present | as above | as above | tungsten resin | 4.9 | nm |
| invention | | | (specific gravity | | |
| D | | | 10.0 g/cm³) | | |
| present | as above | silicone | aluminum alloy | 6.2 | nm |
| invention | | rubber | (specific gravity | | |
| E | | | 2.7 g/cm³) | | |
| present | as above | as above | zinc | 4.5 | nm |
| invention | | | (specific gravity | | |
| Fig. | | | 7.1 g/cm³) | | |
| present | as above | as above | brass | 4.7 | nm |
| invention | | | (specific gravity | | |
| G | | | 8.5 g/cm³) | | |
| present | as above | as above | tungsten resin | 5.0 | nm |
| invention | | | (specific gravity | | |
| H | | | 10.0 g/cm³) | | |
| compara- | as above | not used | not attached | 188.0 | nm |
| tive | | | | | |
| example | | | | | |

In the experiment of which result is shown in Table 1, each of the vibration absorber 5 is attached to the center of the outer bottom plate 25 of the outer case 20 having an outer diameter R (shown in FIG. 1) of 90 mm and a depth D (shown in FIG. 1) of 67 mm. Then, the outer case 20 is vibrated by supplying the voice current, and a condition of the vibration of the outer case 20 is measured. In this experiment, outer diameters of the elastic member 35 and the weight 36 of each elastic member 35 are both 10 mm, thicknesses of the elastic member 35 and the weight 36 are 2 mm and 5 mm respectively.

In this experiment, the outer case 20 made of aluminum alloy having specific gravity of 2.7 g/cm³ is used. The elastic members 35 of the present inventions A to D are made of nitrile rubber. The elastic members 35 of the present inventions E to H are made of silicone rubber.

In this experiment, the weights 36 of the present inventions A and E are made of the aluminum alloy. The weights 36 of the present inventions B and F are made of zinc having specific gravity of 7.1 g/cm³. The weights 36 of the present inventions C and G are made of brass having specific gravity of 8.5 μl cm³. The weights 36 of the present inventions D and H are made of tungsten resin having specific gravity of 10.0 g/cm³. Each of the present invention A to H, the vibration absorber 5 is attached to the same position as shown in FIG. 1.

In addition, as a comparative example, the speaker 1 having no vibration absorber 5 is used. Maximum amplitudes of the outer cases 20 of the present inventions A to H and the comparative example are measured when the voice current is supplied to the voice coil 8 of the measured speaker 1.

As shown in Table 1, while the maximum amplitude of the comparative example having no vibration absorber 5 is 188.0 nm, the maximum amplitude among the present invention A to H is less than or equal to 7.0 nm. Thus, by using the vibration absorber 5, the amplitude of the vibration of the outer case 20 is suppressed.

Further, as shown in Table 1, while the maximum amplitude of the present invention A is 7.0 nm, the maximum amplitude among the present invention B to D is less than or equal to 6.0 nm. Further, while the maximum amplitude of the present invention E is 6.2 nm, the maximum amplitude among the present invention F to H is less than or equal to 5.0 nm. Thus, the weight 36 made of material having specific gravity greater than that of the material composing the outer case 20 suppresses the amplitude of the vibration of the outer case 20. Especially, the weight 36 made of tungsten resin further suppresses the amplitude of the vibration of the outer case 20.

In the embodiment described above, the vibration absorber 5 having the weight 36 and the elastic member 35 is used. However, as shown in FIG. 5, the vibration absorber 5 may be a heavy elastic vibrator 40, and being able to be deformingly vibrated by the vibration of the outer case 20. Incidentally, identical elements in FIG. 5 will be designated by identical reference numerals used for this embodiment described above, and an explanation of those elements will be omitted. As shown in FIG. 5, the vibrator 40 is attached to the center of the outer bottom plate 25 inside the outer case 20. The vibrator 40 of the vibration absorber 5 may be made of above-described tungsten resin. Also, in the embodiment shown in FIG. 5, when the outer case 20 is vibrated, the vibrator 40 is deformingly vibrated to suppress the amplitude of the vibration of the outer case 20, and immediately attenuate the vibration of the outer case 20.

In the embodiment described above, the vibration absorber 5 is enclosed in the outer case 20, and attached to the center of the outer bottom plate 25. However, according to the present invention, the vibration absorber 5 may be attached to the outer cylindrical wall 26 of the outer case 20, or may be attached to anywhere on an outer surface of the outer case 20. Further, the vibration absorber 5 may be attached to anywhere on either an outer or inner surface of the inner case 21. In summary, according to the present invention, the elastic member 35 of the vibration absorber 5 may be attached to anywhere on the case 4 being vibrated by a reaction of the vibration of the diaphragm 10.

The speaker 1 of the present invention may be mounted on various panels such as a door panel or a rear tray of a vehicle, or various boxes mounted on a floor. In particular, when the speaker 1 is attached to the frame 2 of the door panel or the rear tray of a vehicle, the speaker 1 produces a sound having the suitable acoustic characteristics effectively by attenuating the vibrations of the case 4 of the speaker 1. This is because the door panel and the rear tray are not designed to attenuate the vibrations of the case 4 of the speaker 1. According to the present invention, the spring may be used as the elastic member 35. Further, in the present invention, the specific gravity of the weight 36 is not required to be greater than that of the outer case 20. The weight 36 is not required to be made of tungsten resin. The outer case 20 is not required to be made of an aluminum alloy.

According to the above, by mounting a vibration absorber having an elastic member and a weight on a case, the speaker of this embodiment suppresses amplitude of an vibration of the case, and attenuates the vibration of the case to produce a sound having suitable acoustic characteristics.

Further, the case may be formed of a closed end tube, having a bottom plate and a tube extending from a periphery of the bottom plate, and the vibration absorber may be attached to the bottom plate.

Further, the vibration absorber may be enclosed inside the case.

Further, specific gravity of material composing the weight may be greater than that of material composing the case.

Further, the material composing the weight may be tungsten-resin hybrid composite, and the material composing the case may be an aluminum alloy.

The speaker of this embodiment suppresses amplitude of a vibration of the case, and attenuates the vibration of the case to produce a sound having suitable acoustic characteristics by mounting a vibration absorber having a vibrator on a case.

Further, material composing the vibrator may be a tungsten-resin hybrid composite.

Having now fully described the invention, it will be apparent to one of ordinary skill in the art that many changes and modifications can be made thereto without departing from the scope of the invention as set forth herein.

Incidentally, the contents of Japanese Patent Application No. 2004-155059 are hereby incorporated by reference.

1. A speaker comprising:
a speaker unit having an oscillation unit and a magnetic circuit for generating a sound;
a case for enclosing the speaker unit; and
a vibration absorber attached to the case,
whereby the vibration absorber includes an elastic member attached to the case and a weight attached to the elastic member.

2. The speaker as claimed in claim 1,
wherein the case is formed of a closed end tube having a bottom plate and a cylindrical wall extending from a periphery of the bottom plate,
wherein the vibration absorber is attached to the bottom plate.

3. The speaker as claimed in claim 1,
wherein the vibration absorber is installed in the case.

4. The speaker as claimed in claim 1,
wherein specific gravity of the weight is selected to be greater than that of the case.

5. The speaker as claimed in claim 4,
wherein the weight is made of a tungsten-resin hybrid composite, and the case is made of an aluminum alloy.

6. A speaker comprising:
a speaker unit having an oscillation unit and a magnetic circuit for generating a sound;
a case for enclosing the speaker unit; and
a vibration absorber attached to the case,
whereby the vibration absorber includes a vibrator having elasticity.

7. The speaker as described in claim 6,
wherein the vibrator is made of a tungsten-resin hybrid composite.
